(19) United States
(12) Patent Application Publication
(10) Pub. No.: US 2019/0091856 A1
(43) Pub. Date: Mar. 28, 2019

(54) TRANSMISSION

(71) Applicant: Nidec Corporation, Kyoto (JP)

(72) Inventors: Shinji TAKEMOTO, Kyoto (JP); Satoshi YAMANE, Kyoto (JP); Tomoyoshi YOKOGAWA, Kyoto (JP); Masaaki NAKAGAWA, Kyoto (JP); Shigekatsu MATSUDA, Kyoto (JP)

(21) Appl. No.: 16/102,821

(22) Filed: Aug. 14, 2018

(30) Foreign Application Priority Data
Sep. 22, 2017 (JP) 2017-181927

(51) Int. Cl. B25J 9/10; F16H 57/12; F16H 1/28

(52) U.S. Cl. CPC B25J 9/103; F16H 57/12; F16H 2001/2881; F16H 2057/128; F16H 1/2863

(57) ABSTRACT

A transmission includes a first rotating portion, an eccentric body, a bearing, an external gear, an internal gear, carrier pins, and a second rotating portion. The first rotating portion rotates about a central axis. The eccentric body rotates therewith and a distance from the central axis to an outer surface thereof varies circumferentially. The bearing is provided on the eccentric body. The external gear includes through holes and is provided on the bearing. The internal gear is cylindrical, surrounds the central axis, and is disposed radially outside the external gear. The carrier pins are columnar and inserted into the through holes. The second rotating portion, to which upper portions of the carrier pins are fixed, rotates about the central axis. The external and internal gears have different numbers of teeth. The tooth of the external gear farthest from the central axis meshes with the internal gear. The diameters of the carrier pins decrease upward.

### CROSS REFERENCE TO RELATED APPLICATIONS

This application claims the benefit of priority to Japanese Patent Application No. 2017-181927 filed on Sep. 22, 2017. The entire contents of this application are hereby incorporated herein by reference.

### BACKGROUND OF THE INVENTION

### 1. Field of the Invention

The present disclosure relates to a transmission.

### 2. Description of the Related Art

An eccentrically oscillating speed reduction mechanism often has an internal-tooth gear and an external-tooth gear disposed inside the internal-tooth gear. The external-tooth gear meshes with the internal-tooth gear and oscillates along the internal surface of the internal-tooth gear. Such an eccentrically oscillating speed reduction mechanism is small and can obtain a high reduction ratio.

In recent years, the demand for small robots that work in cooperation with people has been increasing. It has been proposed to use an actuator combining the above-described eccentrically oscillating speed reducer and a motor for a joint of a small robot. However, this type of small robot requires smooth motion. In addition, this type of small robot has a capability (back-drivability) that facilitates transmission to an input side in the case where an external force is applied to an output side. By improving back-drivability, breakage of the actuator or the application on which the actuator is mounted can be easily suppressed when an impact is applied to the output side. Therefore, improvement of back-drivability is required.

Improvement of back-drivability can be realized by, for example, increasing the gap between the meshing external teeth and internal teeth, the gap between the bearing and the external teeth, the gap between the shaft and the bearing, and the like (backlash). However, if the backlash is increased, during reverse rotation, abrasion between the gears tends to occur due to dimensional deviation, shock, and the like, and the mechanical life is shortened. On the other hand, if the backlash is reduced, the gap between the external teeth and the internal teeth becomes narrower, and the back-drivability decreases. In other words, there is a trade-off relationship between back-drivability and backlash.

### SUMMARY OF THE INVENTION

An exemplary embodiment of the present disclosure is an eccentrically oscillating transmission. The transmission includes a first rotating portion, a first eccentric body, a first bearing, a first external-tooth gear, an internal-tooth gear, a plurality of carrier pins, and a second rotating portion. The first rotating portion rotates about a central axis that extends in a top-bottom direction. The first eccentric body rotates together with the first rotating portion and the distance from the central axis to an outer peripheral surface of the first eccentric body varies with a position in a circumferential direction. The first bearing is provided on the outer peripheral surface of the first eccentric body. The first external-tooth gear includes a plurality of first through holes penetrating therethrough in an axial direction and is provided on an outer peripheral surface of the first bearing. The internal-tooth gear has a cylindrical shape surrounding the central axis in the circumferential direction and is disposed outward of the first external-tooth gear in a radial direction. The carrier pins each have a columnar shape extending in the axial direction and are inserted into corresponding ones of the plurality of the first through holes. The second rotating portion, to which an upper end portion of each of the plurality of carrier pins in the axial direction is fixed, rotates about the central axis. A number of teeth of the first external-tooth gear and a number of teeth of the internal-tooth gear are different. An external tooth of the first external-tooth gear provided at a position farthest from the central axis meshes with the internal-tooth gear. A diameter of each of the carrier pins gradually decreases from a lower side toward an upper side in the axial direction.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a vertical cross-sectional view of a transmission of an exemplary embodiment of the present disclosure.

FIG. 2 is an exploded perspective view of the transmission of FIG. 1.

FIG. 3 is a horizontal cross-sectional view of line III-III in FIG. 1.

FIG. 4 is a diagram illustrating results for a simulation that measured backlash and back-drivability.

### DETAILED DESCRIPTION OF THE PREFERRED EMBODIMENTS

Hereinafter, exemplary embodiments of the present disclosure will be described with reference to the drawings. Further, in the present disclosure, the direction parallel to a central axis of a transmission is referred to as the “axial direction”, the direction perpendicular to the central axis is referred to as the “radial direction”, and the direction along a circular arc with the central axis as the center is referred to as the “circumferential direction”. In addition, in the present disclosure, the shape and positional relationship of each element will be described with the axial direction taken as the top-bottom direction with a first carrier member side of a second rotating portion being above a first rotating portion. However, in practicality, there is no intention to limit the orientation of the transmission according to the present disclosure to this top-bottom definition. In addition, the above-mentioned “parallel direction” also includes a direction that is substantially parallel. In addition, the above-mentioned “perpendicular direction” also includes a direction that is substantially perpendicular.

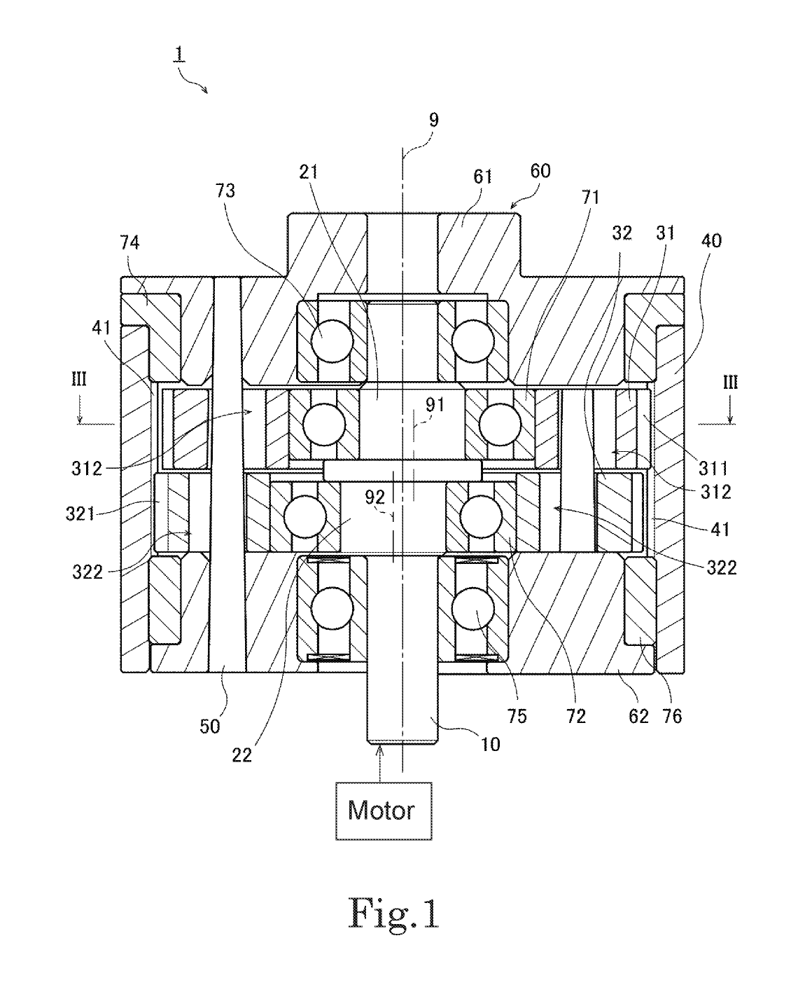

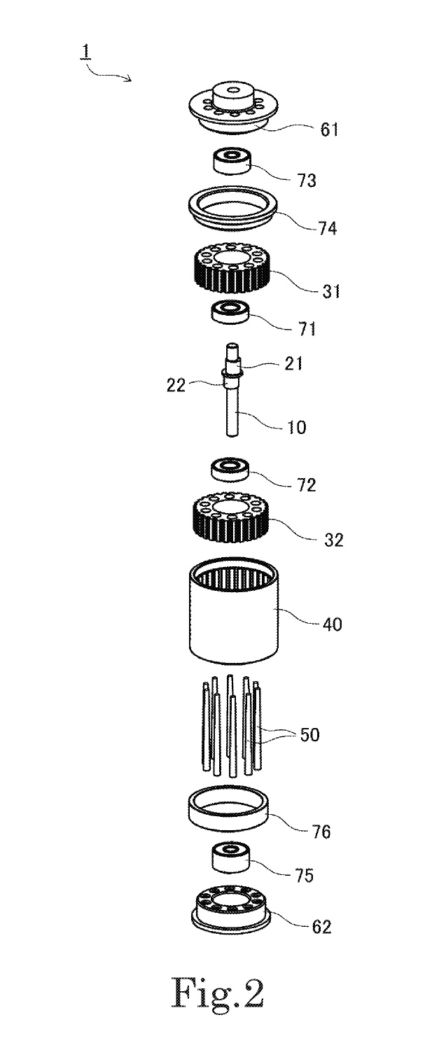

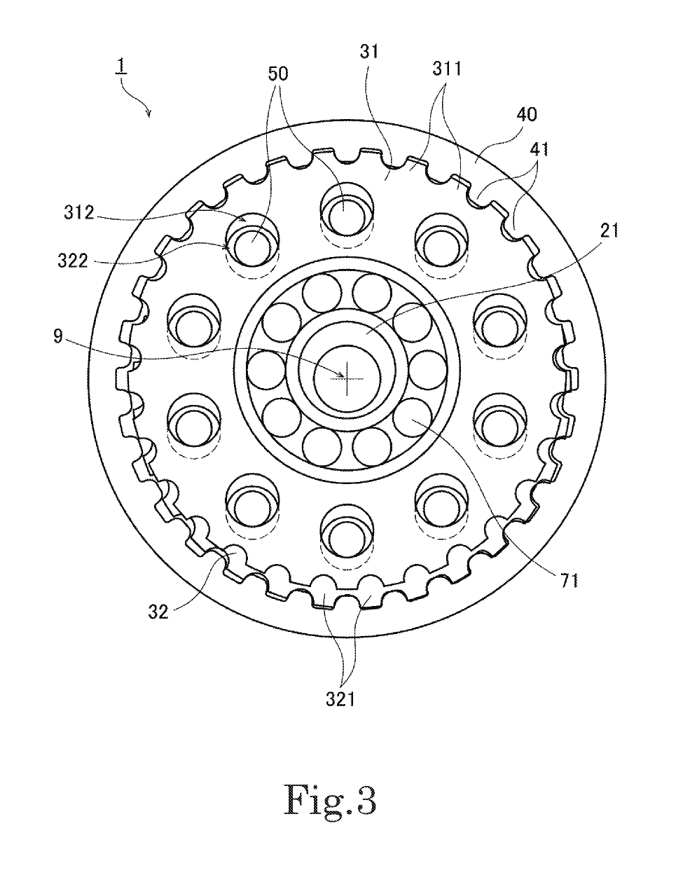

FIG. 1 is a vertical cross-sectional view of a transmission 1 of the present embodiment. FIG. 2 is an exploded perspective view of the transmission 1. FIG. 3 is a horizontal cross-sectional view of line III-III in FIG. 1. Further, in FIG. 3, hatching is omitted to avoid complicating the drawing.

The transmission 1 is a gear speed reducer that converts a rotational motion having a first rotational speed (input rotational speed) into a rotational motion having a second rotational speed (output rotational speed) lower than the first rotational speed. The transmission 1 is used, for example, as a joint of a small robot such as a service robot that performs work in cooperation with a person. However, a transmission having an equivalent structure may be used for other applications such as a large industrial robot, a machine tool, an X-Y table, a material cutting device, a conveyer line, a turntable, a rolling roller, and the like. The transmission 1 is an eccentrically oscillating transmission.

The transmission 1 includes a first rotating portion 10, a first eccentric body 21, a second eccentric body 22, a first external-tooth gear 31, a second external-tooth gear 32, a frame 40, a plurality of carrier pins 50, and a second rotating portion 60.

The first rotating portion 10 is a columnar member extending in the top-bottom direction along a central axis 9. As conceptually illustrated in FIG. 1, the first rotating portion 10 is connected to a motor, which is a driving source, directly or via another power transmission mechanism. When the motor is driven, due to the power obtained from the motor, the first rotating portion 10 rotates at a first rotational speed about the central axis 9. That is, in the present embodiment, the first rotating portion 10 is an input portion.

The first eccentric body 21 is fixed to the outer peripheral surface of the first rotating portion 10. Thus, the first eccentric body 21 rotates together with the first rotating portion 10. The first rotating portion 10 and the first eccentric body 21 may be a single member or different members. As illustrated in FIG. 3, the first eccentric body 21 has a perfectly circular outer peripheral surface when viewed from the axial direction. A central axis 91 of the first eccentric body 21 is positioned away from the central axis 9. That is, the first eccentric body 21 is a perfect circle when viewed from the axial direction, and the center of the perfect circle is located away from the central axis 9. Therefore, the distance from the central axis 9 to the outer peripheral surface of the first eccentric body 21 varies with the position in the circumferential direction.

The second eccentric body 22 is fixed to the outer peripheral surface of the first rotating portion 10. The second eccentric body 22 is disposed at a position different from a position of the first eccentric body 21 in the axial direction. The second eccentric body 22 and the first eccentric body 21 are arranged with a gap therebetween in the axial direction. However, it is not necessary to provide a gap. The second eccentric body 22 rotates together with the first rotating portion 10. The first rotating portion 10 and the second eccentric body 22 may be a single member or different members. Like the first eccentric body 21, the second eccentric body 22 has a perfectly circular outer peripheral surface when viewed from the axial direction. A central axis 92 of the second eccentric body 22 is positioned away from the central axis 9. That is, the second eccentric body 22 is a perfect circle when viewed from the axial direction, and the center of the perfect circle is positioned away from the central axis 9. Therefore, the distance from the central axis 9 to the outer peripheral surface of the second eccentric body 22 varies with the position in the circumferential direction.

In addition, the central axis 92 of the second eccentric body 22 is positioned away from the central axis 91 of the first eccentric body 21 by 180 degrees with respect to the central axis 9. That is, the first eccentric body 21 and the second eccentric body 22 are point symmetric with respect to the central axis 9.

When the first rotating portion 10 rotates about the central axis 9, the first eccentric body 21 and the second eccentric body 22 rotate about the central axis 9. At this time, the central axis 91 of the first eccentric body 21 and the central axis 92 of the second eccentric body 22 also rotate about the central axis 9. In addition, as described above, the central axis 91 of the first eccentric body 21 and the central axis 92 of the second eccentric body 22 are positioned away from each other by 180 degrees with respect to the central axis 9. Therefore, the position of the center of gravity of the first eccentric body 21 and the second eccentric body 22 as a whole is always located on the central axis 9. Therefore, it is possible to suppress fluctuation of the center of gravity due to the rotation of the first eccentric body 21 and the second eccentric body 22.

The first external-tooth gear 31 is disposed outward of the first eccentric body 21 in the radial direction. A first bearing 71 is interposed between the first eccentric body 21 and the first external-tooth gear 31. That is, the transmission 1 includes the first bearing 71. The first bearing 71 is provided on the outer peripheral surface of the first eccentric body 21. The first external-tooth gear 31 is provided on the outer peripheral surface of the first bearing 71. As the first bearing 71, for example, a ball bearing is used. The first external-tooth gear 31 is rotatably supported by the first bearing 71 with the central axis 91 as the center. As illustrated in FIG. 3, a plurality of external teeth 311 are provided on the outer peripheral portion of the first external-tooth gear 31. Each of the external teeth 311 protrudes outward in the radial direction. The first external-tooth gear 31 has a plurality of first through holes 312 (ten in the example of FIG. 3). Each of the first through holes 312 penetrates through the first external-tooth gear 31 in the axial direction. The plurality of the first through holes 312 are arranged at equiangular intervals along the circumferential direction with the central axis 91 as the center.

The second external-tooth gear 32 is disposed outward of the second eccentric body 22 in the radial direction. A second bearing 72 is interposed between the second eccentric body 22 and the second external-tooth gear 32. That is, the transmission 1 includes the second bearing 72. The second bearing 72 is provided on the outer peripheral surface of the second eccentric body 22. The second external-tooth gear 32 is provided on the outer peripheral surface of the second bearing 72. As the second bearing 72, for example, a ball bearing is used. The second external-tooth gear 32 is rotatably supported by the second bearing 72 with the central axis 92 as the center. Like the first external-tooth gear 31, the second external-tooth gear 32 is provided with a plurality of external teeth 321 on the outer peripheral portion of the second external-tooth gear 32. The number of the external teeth 321 of the second external-tooth gear 32 is the same as the number of the external teeth 311 of the first external-tooth gear 31. In addition, the second external-tooth gear 32 has a plurality of second through holes 322 penetrating therethrough in the axial direction. The plurality of the second through holes 322 are arranged at equiangular intervals along the circumferential direction with the central axis 92 as the center. In addition, the diameter of each of the first through holes 312 is the same as the diameter of each of the second through holes 322. Furthermore, each of the plurality of the first through holes 312 and corresponding one of the plurality of the second through holes 322 overlap in the axial direction.

The frame 40 is a cylindrical member that surrounds the central axis 9 in the circumferential direction and that extends in the axial direction. The frame 40 surrounds the outer sides of the first external-tooth gear 31 and the second external-tooth gear 32 in the radial direction. As illustrated in FIG. 3, a plurality of internal teeth 41 are provided on the inner peripheral surface of the frame 40. Each of the plurality of the internal teeth 41 protrudes inward from the inner peripheral surface of the frame 40 in the radial direction. In the present embodiment, the internal-tooth gear including the internal teeth 41 is a portion of the frame 40. That is, the transmission 1 is provided with the internal-tooth gear. The internal-tooth gear surrounds the central axis 9 in the circumferential direction and has a cylindrical shape extending in the axial direction. The internal-tooth gear opposes the first external-tooth gear 31 and the second external-tooth gear 32 in the radial direction. The internal-tooth gear is disposed radially outside the first external-tooth gear 31. However, the internal-tooth gear may be a member separate from the frame 40. In the case where the internal teeth 41 and the frame 40 are portions of the same member as in the present embodiment, because there is no need to provide an internal-tooth gear having the internal teeth 41 separately from the frame 40, it becomes easy to decrease the size of the transmission 1.

The plurality of the external teeth 311 of the first external-tooth gear 31 and the plurality of the external teeth 321 of the second external-tooth gear 32 each partially mesh with a portion of the plurality of the internal teeth 41 of the frame 40. More specifically, the external teeth 311 of the first external-tooth gear 31 that are located farthest from the central axis 9, and the external teeth 321 of the second external-tooth gear 32 that are located farthest from the central axis 9, mesh with the internal teeth 41. That is, the internal-tooth gear meshes with the external teeth 311 of the first external-tooth gear 31 that are farthest from the central axis 9 and meshes with the external teeth 321 of the second external-tooth gear 32 that are farthest from the central axis 9. That is, the position at which the external teeth 311 of the first external-tooth gear 31 and the internal teeth 41 of the frame 40 mesh and the position at which the external teeth 321 of the second external-tooth gear 32 and the internal teeth 41 of the frame 40 mesh are point symmetric about the central axis 9. That is, the position at which the internal-tooth gear and the first external-tooth gear 31 mesh and the position at which the internal-tooth gear and the second external-tooth gear 32 mesh are different from each other in the axial direction and are point symmetric about the central axis 9.

Further, as described above, the first external-tooth gear 31 and the second external-tooth gear 32 have the same configuration and are point symmetric about the central axis 9. Therefore, in the following description, only the first external-tooth gear 31 will be described.

When the first rotating portion 10 rotates about the central axis 9, the first external-tooth gear 31 revolves around the central axis 9 together with the central axis 91. In addition, as a portion of the plurality of external teeth 311 of the first external-tooth gear 31 and the internal teeth 41 of the frame 40 mesh with each other, the first external-tooth gear 31 rotates about its axis. Here, the number of the internal teeth 41 of the frame 40 is larger than the number of the external teeth 311 of the first external-tooth gear 31. For this reason, the position at which the external teeth 311 mesh with the internal teeth 41 of the frame 40 shifts with each revolution of the first external-tooth gear 31. As a result, the first external-tooth gear 31 rotates in a direction opposite to the rotation direction of the first rotating portion 10 at a second rotational speed lower than the first rotational speed. Therefore, the positions of the first through holes 312 of the first external-tooth gear 31 also rotate at the second rotational speed. During operation of the transmission 1, the first external-tooth gear 31 performs a rotary motion combining such revolution and rotation. The number of teeth of the first external-tooth gear 31 and the number of teeth of the internal-tooth gear are different.

Assuming that the number of the external teeth 311 of the first external-tooth gear 31 is N and the number of the internal teeth 41 of the frame 40 is M, the reduction ratio P of the transmission 1 is P=(first rotational speed)/(second rotational speed)=N/(M-N). In the example of FIG. 3, because N=29 and M=30, the reduction ratio in this example is P=29. That is, the second rotational speed is a rotational speed of 1/29 the first rotational speed. However, the number N of the external teeth 311 and the number M of the internal teeth 41 may be other values.

The carrier pins 50 are columnar members extending in the axial direction. The diameter of the upper end portion of each of the carrier pins 50 in the axial direction and the diameter of the lower end portion in the axial direction are constant. In addition, the diameter of the upper end portion of the carrier pin 50 in the axial direction is smaller than the diameter of the lower end portion in the axial direction. The diameter between the lower end portion of the carrier pins 50 in the axial direction and the upper end portion gradually decreases from the lower side to the upper side in the axial direction. That is, the diameter of the carrier pins 50 gradually decreases from the lower side to the upper side in the axial direction. Further, the upper end portion and the lower end portion having constant diameters have a certain length in the axial direction.

The plurality of the carrier pins 50 are annularly arranged at equiangular intervals along the circumferential direction about the central axis 9. The carrier pins 50 are inserted into the first through holes 312 of the first external-tooth gear 31 and the second through holes 322 of the second external-tooth gear 32, which overlap in the axial direction. The plurality of the carrier pins 50 are inserted into corresponding ones of the plurality of the first through holes 312. As described above, the first through holes 312 and the second through holes 322 rotate at the second rotational speed after decelerating. The carrier pins 50 inserted into the first through holes 312 and the second through holes 322 rotate together with the first through holes 312 and the second through holes 322 at the second rotational speed with the central axis 9 as the center.

The second rotating portion 60 has a first carrier member 61 that is annular and a second carrier member 62 that is annular. The first carrier member 61 is disposed above the first external-tooth gear 31 in the axial direction. A bearing 73 is interposed between the first rotating portion 10 and the first carrier member 61. In addition, a bearing 74 is interposed between the first carrier member 61 and the frame 40.

The second carrier member 62 is disposed below the second external-tooth gear 32 in the axial direction. A bearing 75 is interposed between the first rotating portion 10 and the second carrier member 62. In addition, a bearing 76 is interposed between the second carrier member 62 and the frame 40. As the bearing 73 and the bearing 75, for example, ball bearings are used. As the bearing 74 and the bearing 76, for example, plain bearings each made of a resin such as polyacetal are used.

The upper end portion of each of the carrier pins 50 in the axial direction is fixed to the first carrier member 61. That is, the upper end portions of the plurality of the carrier pins 50 in the axial direction are fixed to the second rotating portion 60. In the present embodiment, the upper end portions of the carrier pins 50 in the axial direction are inserted into holes provided in the first carrier member 61 and fixed thereto. As described above, the diameter of the upper end portion of each of the carrier pins 50 in the axial direction is constant. Therefore, the diameter of each of the holes provided in the first carrier member 61 may also be constant in the axial direction, which facilitates manufacturing. Further, as a method of fixing the carrier pins 50 to the first carrier member 61, for example, press fitting is used.

The lower end portion of each of the carrier pins 50 in the axial direction is fixed to the second carrier member 62. In the present embodiment, the lower end portions of the carrier pins 50 in the axial direction are inserted into holes provided in the second carrier member 62 and fixed thereto. As described above, the diameter of the lower end portion of each of the carrier pins 50 in the axial direction is constant. Therefore, the diameter of the holes provided in the second carrier member 62 may also be constant in the axial direction, which facilitates manufacturing. Further, as a method of fixing the carrier pins 50 to the second carrier member 62, for example, press fitting is used.

In this manner, by fixing the first carrier member 61 and the second carrier member 62 to the plurality of carrier pins 50, the first carrier member 61 and the second carrier member 62 are also moved in accordance with the rotation of the plurality of carrier pins 50 and rotate about the central axis 9 at the second rotational speed. In other words, the second rotating portion 60 rotates about the central axis 9 at the second rotational speed. The second rotating portion 60 is connected to a member to be driven either directly or via another power transmission mechanism. That is, in the present embodiment, the second rotating portion 60 is an output portion.

In the transmission 1 of the present embodiment, the diameter of each of the carrier pins 50 gradually decreases from the lower side to the upper side in the axial direction. With this configuration, it is possible to improve the back-drivability while reducing the backlash of the transmission 1.

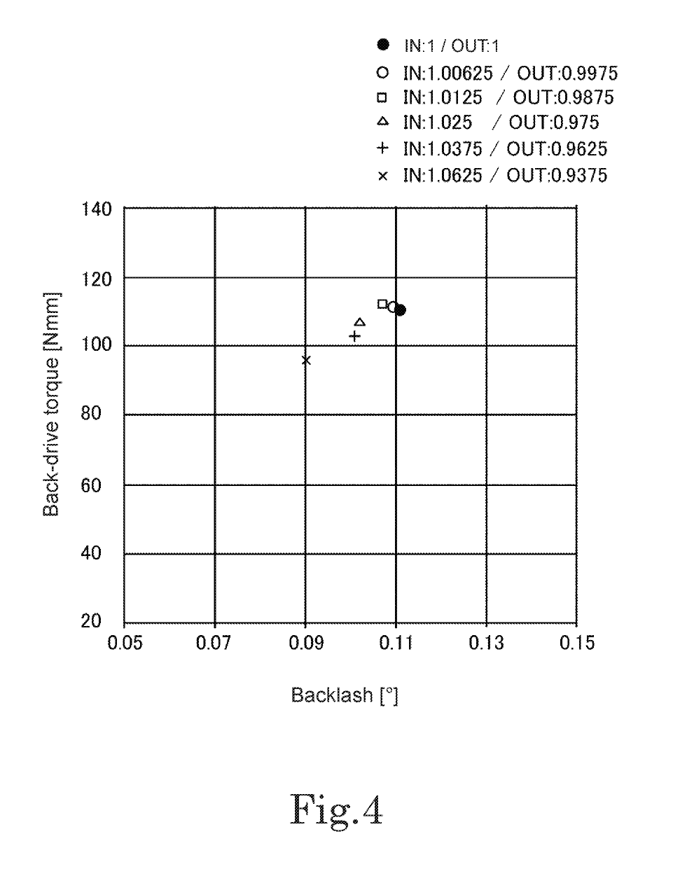

FIG. 4 is a diagram illustrating results of a simulation that measured backlash and back-drive torque. The vertical axis of FIG. 4 illustrates the back-drive torque and the horizontal axis illustrates the backlash.

The back-drive torque is the magnitude of the resistance when the second rotating portion 60 as an output portion is rotated by an external force. When the back-drive torque is small, the rotational resistance of the second rotating portion 60 is small and rotation loss is reduced. That is, back-drivability is improved. In addition, the backlash is a movable angle range in the rotational direction of the second rotating portion 60 when the first rotating portion 10 is fixed, and is a gap between the meshing external teeth and internal teeth. In FIG. 4, the units are angular degrees.

In the simulation, the diameters of the upper end portions and lower end portions of the carrier pins 50 in the axial direction are changed. In the upper right of FIG. 4, an explanation is given regarding what types of carrier pins were used for the simulation results. In this description, “IN” refers to the diameter of the lower end portions of the carrier pins in the axial direction and “OUT” refers to the diameter of the upper end portions of the carrier pins in the axial direction.

The black circle mark in FIG. 4 is a simulation result using carrier pins having a constant diameter in the axial direction. The white circle mark is a simulation result using carrier pins in which the diameter of the lower end portions in the axial direction is 1.00625% of the diameter of the carrier pins indicated by the black circle mark and the diameter of the upper end portions is 0.9975% of the diameter of the carrier pins indicated by the black circle mark. The square mark is a simulation result using carrier pins in which the diameter of the lower end portions in the axial direction is 1.0125% of the diameter of the carrier pins indicated by the black circle mark and the diameter of the upper end portion is 0.9875% of the diameter of the carrier pins indicated by the black circle mark. The triangular mark is a simulation result using carrier pins in which the diameter of the lower end portions in the axial direction is 1.025% of the diameter of the carrier pins indicated by the black circle mark and the diameter at the upper end portions is 0.975% of the diameter of the carrier pins indicated by the black circle mark. The plus mark is a simulation result using carrier pins in which the diameter of the lower end portions in the axial direction is 1.0375% of the diameter of the carrier pins indicated by the black circle mark and the diameter of the upper end portions is 0.9625% of the diameter of the carrier pins indicated by the black circle mark. The X mark is a simulation result using carrier pins in which the diameter of the lower end portion in the axial direction is 1.0625% of the diameter of the carrier pins indicated by the black circle mark and the diameter at the upper end portion is 0.9375% of the diameter of the carrier pins indicated by the black circle mark.

When the diameter of the lower end portions of the carrier pins in the axial direction is large and the diameter of the upper end portion becomes small, the inclination angle of the outer peripheral surface of the carrier pins with respect to the axial direction becomes large. As can be understood from FIG. 4, it is preferable to use carrier pins having an outer peripheral surface with a large inclination angle, that is, to use carrier pins having a larger diameter at the lower end portions in the axial direction and a smaller diameter at the upper end portions because the backlash is small and the back-drive torque also becomes small.

As described above, by reducing the diameter of the carrier pins 50 from the lower side in the axial direction to the upper side, it is possible to improve the back-drivability while reducing the backlash.

Further, the transmission 1 is not limited to the above-described configuration. For example, the transmission 1 includes the first external-tooth gear 31 and the second external-tooth gear 32, but it may have only one of the external-tooth gears. In addition, three or more external gears may be provided. Furthermore, the number of external teeth of the external-tooth gear and the number of internal teeth of the internal-tooth gear can be appropriately changed.

The present disclosure can be applied to, for example, a transmission.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A transmission of an eccentrically oscillating type, comprising:
a first rotating portion that rotates about a central axis extending in a top-bottom direction;
a first eccentric body that rotates together with the first rotating portion, for which a distance from the central axis to an outer peripheral surface of the first eccentric body varies with a position in a circumferential direction;
a first bearing provided on the outer peripheral surface of the first eccentric body;
a first external-tooth gear that includes a plurality of first through holes penetrating therethrough in an axial direction and that is provided on an outer peripheral surface of the first bearing;
an internal-tooth gear that has a cylindrical shape surrounding the central axis in the circumferential direction and that is disposed outward of the first external-tooth gear in a radial direction;
a plurality of carrier pins that each have a columnar shape extending in the axial direction and that are inserted into corresponding ones of the plurality of the first through holes; and
a second rotating portion to which an upper end portion of each of the plurality of carrier pins in the axial direction is fixed and that rotates about the central axis; wherein
a number of teeth of the first external-tooth gear and a number of teeth of the internal-tooth gear are different;
an external tooth of the first external-tooth gear located farthest from the central axis meshes with the internal-tooth gear; and
a diameter of each of the carrier pins decreases from a lower side toward an upper side in the axial direction.

2. The transmission according to claim 1, wherein the first eccentric body is a perfect circle when viewed in the axial direction, and a center of the perfect circle is located off the central axis.

3. The transmission according to claim 1, further comprising:
a second eccentric body that rotates together with the first rotating portion, for which a distance from the central axis to an outer peripheral surface of the second eccentric body varies with a position in the circumferential direction, and that is located at a position different from a position of the first eccentric body in the axial direction;
a second bearing provided on the outer peripheral surface of the second eccentric body; and
a second external-tooth gear that includes a plurality of second through holes penetrating therethrough in the axial direction and that is provided on an outer peripheral surface of the second bearing, a number of external teeth of the second external-tooth gear being same as that of the first external-tooth gear; wherein
each of the plurality of first through holes and a corresponding one of the plurality of the second through holes overlap in the axial direction;
the carrier pins are inserted into the first through holes and the second through holes that overlap in the axial direction;
the internal-tooth gear extends in the axial direction and opposes the first external-tooth gear and the second external-tooth gear in the radial direction;
an external tooth of the second external-tooth gear located farthest from the central axis meshes with the internal-tooth gear; and
a position at which the internal-tooth gear and the first external-tooth gear mesh and a position at which the internal-tooth gear and the second external-tooth gear mesh are different from each other in the axial direction.

4. The transmission according to claim 3, wherein the position at which the internal-tooth gear and the first external-tooth gear mesh and the position at which the internal-tooth gear and the second external-tooth gear mesh are point symmetric about the central axis.

5. The transmission according to claim 3, wherein the second eccentric body is a perfect circle when viewed from the axial direction and a center of the perfect circle is located off the central axis.

6. The transmission according to claim 3, wherein a diameter of each of the first through holes is same as a diameter of each of the second through holes.

7. The transmission according to claim 3, wherein the first eccentric body and the second eccentric body are disposed with a gap therebetween in the axial direction.

8. The transmission according to claim 1, wherein diameters of the upper end portion and a lower end portion of each of the carrier pins in the axial direction are constant and a diameter between the upper end portion and the lower end portion of the carrier pin gradually decreases from the lower side toward the upper side in the axial direction.

9. The transmission according to claim 1, wherein
the first rotating portion is an input portion that rotates at a first rotational speed by power obtained from a motor; and
the second rotating portion is an output portion that rotates at a second rotational speed lower than the first rotational speed.
